(19) United States
(12) Patent Application Publication
(10) Pub. No.: US 2020/0040602 A1
(43) Pub. Date: Feb. 6, 2020

(54) DOOR LOCK

(71) Applicant: THASE ENTERPRISE CO., LTD., New Taipei City (TW)

(72) Inventor: Ching-Tien Lin, New Taipei City (TW)

(21) Appl. No.: 16/286,782

(22) Filed: Feb. 27, 2019

(30) Foreign Application Priority Data
Aug. 3, 2018 (TW) 107127098

(51) Int. Cl. E05B 9/02; E05C 19/02; E05B 3/04

(52) U.S. Cl. CPC E05B 9/02; E05B 3/04; E05C 19/028

(57) ABSTRACT

Provided is a door lock, including at least one latch portion, and a controlling portion for actuating the latch portion. The controlling portion includes a base having a configuration hole and a linkage assembly disposed on the base. The linkage assembly includes an actuating member movably disposed on the base, a driving member connected to the actuating member, a sliding member connected to the driving member, disposed on the base and having at least one opening, and a connecting member connected to the sliding member and the latch portion for enabling the sliding member to drive the connecting member and actuate the latch portion and exposing the configuration hole from the opening when the actuating member drives the driving member to actuate the sliding member. When the door lock is repaired, the screw thread can be set in the configuration hole from the opening without removing the linkage assembly.

### BACKGROUND

### 1. Technical Field

The present disclosure relates to door locks, and, in particular, to a structural improvement of a heaven and earth lock at a handle pressing portion.

### 2. Description of Related Art

A commonly used heaven and earth lock (such as Taiwan Patent No. M524384 or U.S. patent application Ser. No. 15/092,891) can be used for fire doors.

However, the slider 32 of the slider assembly 3 (shown in FIG. 4 of the aforementioned patent) of the conventional heaven and earth lock at the handle pressing portion will block the opening 102 (shown in FIG. 2 of the aforementioned patent) of the base. The heaven and earth lock is thus hard to be assembled or overhauled.

Therefore, how to overcome the above-mentioned problems of the prior art has become urgent in this technical field.

### SUMMARY

According to an embodiment of the present disclosure, a door lock is provided. The door lock includes at least one latch portion and a controlling portion configured for actuating the latch portion. The controlling portion includes a base having a configuration hole and a linkage assembly disposed on the base. The linkage assembly includes an actuating member movably disposed on the base, a driving member connected to the actuating member, a sliding member connected to the driving member, movably disposed on the base and having at least one opening, and a connecting member connected to the sliding member and the latch portion and configured for enabling the sliding member to drive the connecting member and actuate the latch portion and exposing the configuration hole from the opening when the actuating member drives the driving member to actuate the sliding member.

In an embodiment, the actuating member is movable away from or close to the base.

In an embodiment, the actuating member is movable along a surface of the base.

In an embodiment, the driving member is pivotally connected with the base such that one side of the driving member is connected to the actuating member and the other side thereof is connected to the sliding member.

In an embodiment, the sliding member is movable along a surface of the base.

In an embodiment, the door lock further comprises an adjusting member for adjusting a position of the sliding member. In another embodiment, the adjusting member has a screw thread for being engaged with the sliding member.

In an embodiment, the door lock further comprises a passive member used to cooperate with the sliding member. In another embodiment, the door lock further comprises an adjusting member connected to the passive member and the sliding member for adjusting a distance between the passive member and the sliding member.

In an embodiment, the actuating member and the sliding member move in different directions.

### BRIEF DESCRIPTION OF THE DRAWINGS

The disclosure can be more fully understood by reading the following detailed description of the embodiments, with reference made to the accompanying drawings, wherein:

FIG. 1A is a 3D schematic diagram showing a door lock according to an embodiment of the present disclosure;

FIG. 1B is a 3D schematic diagram showing a latch portion of the door lock according to an embodiment of the present disclosure;

FIG. 2A is a 3D schematic diagram showing a controlling portion of the door lock according to an embodiment of the present disclosure;

FIG. 2B is a 3D schematic diagram of FIG. 2A with the shield omitted;

FIG. 3A is a 3D schematic diagram showing the decomposition of a linkage assembly of the controlling portion of the door lock according to an embodiment of the present disclosure;

FIG. 3B is a 3D schematic diagram showing the linkage assembly of the controlling portion of the door lock according to an embodiment of the present disclosure;

FIG. 4A is a 3D schematic diagram showing the controlling portion of the door lock according to an embodiment of the present disclosure;

FIG. 4B is a 3D schematic diagram showing the decomposition of FIG. 4A;

FIG. 5A is a 3D schematic diagram showing the controlling portion of the door lock according to an embodiment of the present disclosure;

FIG. 5B is a 3D schematic diagram showing the decomposition of FIG. 5A; and

FIGS. 6A and 6B are 3D schematic diagrams showing the controlling portion of the door lock when being actuated according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

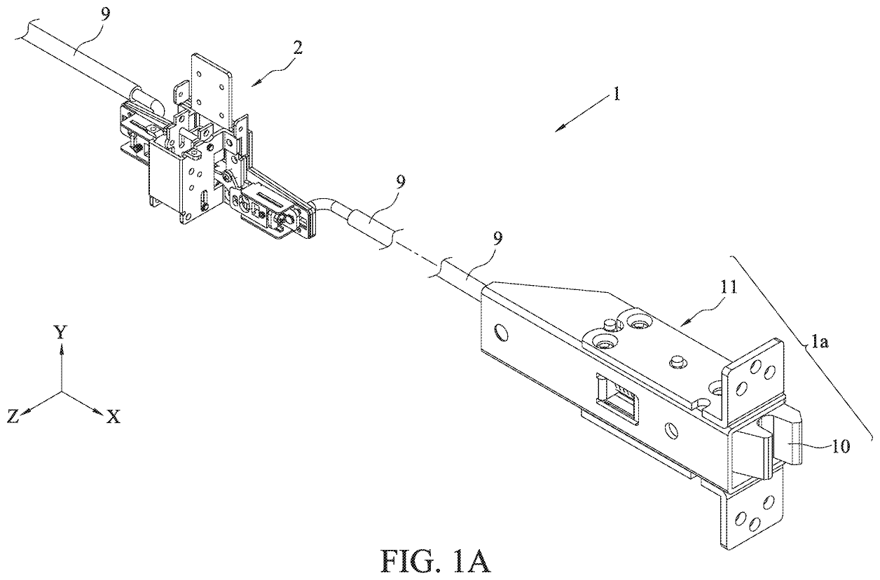

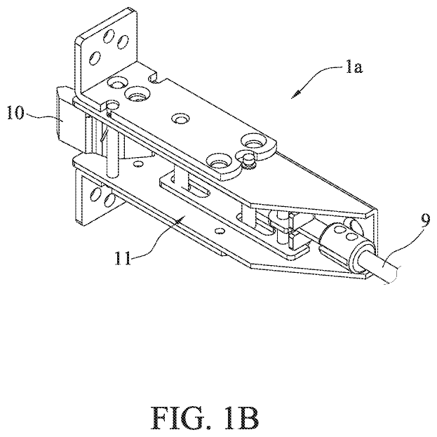

FIGS. 1A and 1B are 3D schematic diagrams of a door lock 1 of an embodiment according to the present disclosure. The door lock 1 includes at least one latch portion 1a and a controlling portion 2 for actuating the latch portions 1a.

In an embodiment, the door lock 1 is a heaven and earth lock for a fire door, and the latch portions 1a (one of which is omitted in the figure) are respectively disposed on the opposite sides of the controlling portion 2, such that the controlling portion 2 can simultaneously actuate the latch portions 1a by using a connecting rod 9.

The latch portion 1a includes a latch 10 and a driving mechanism 11 for driving the latch 10 to extend and retract. The connecting rod 9 drives the driving mechanism 11, thereby causing the latch 10 to extend or retract. It should be understood that there are many kinds of configurations of the driving mechanism 11, and there are no special restrictions.

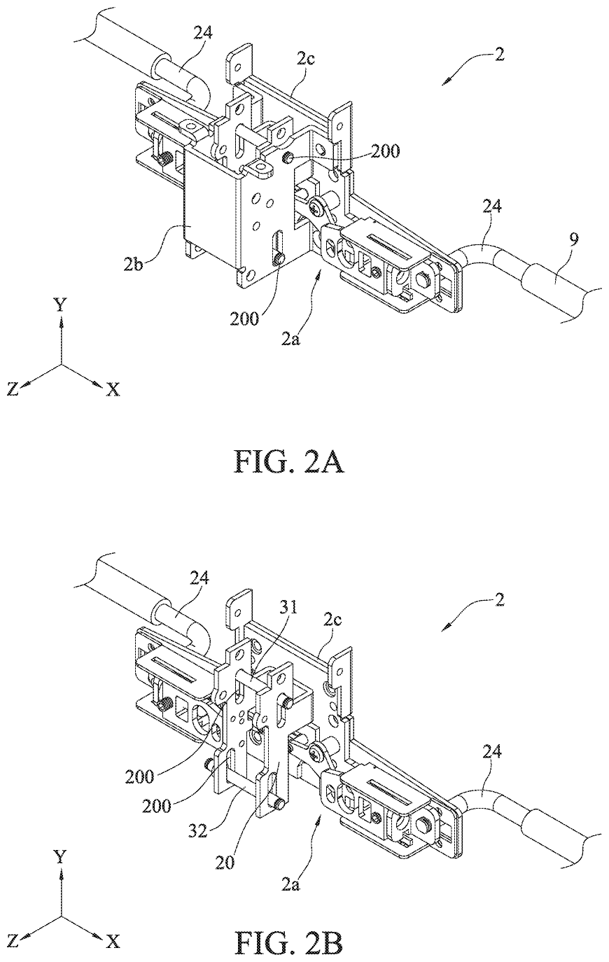

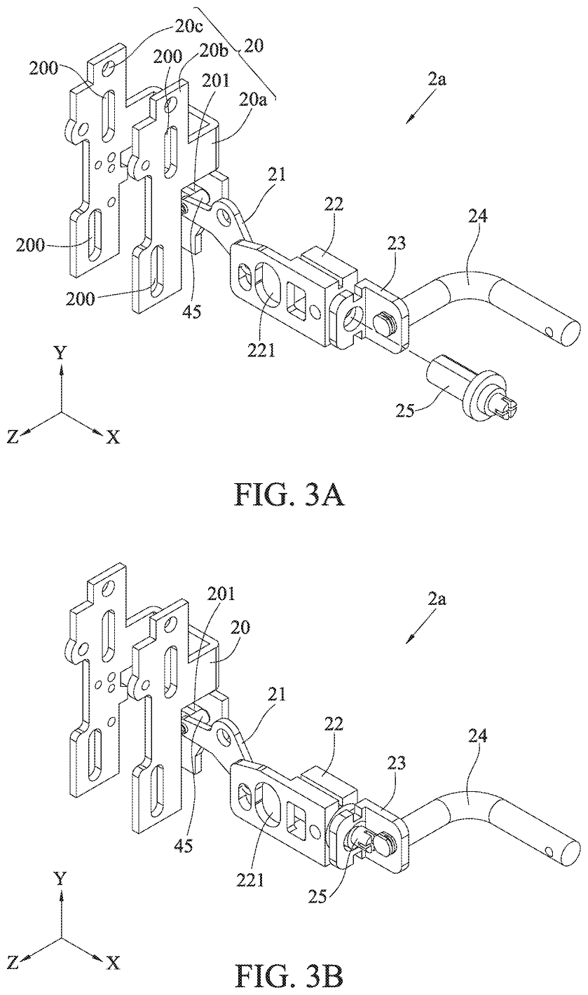

FIGS. 2A and 2B are 3D schematic diagrams of the controlling portion 2 of an embodiment according to the present disclosure. FIGS. 3A and 3B are 3D schematic diagrams of a linkage assembly 2a of the controlling portion 2 of an embodiment according to the present disclosure.

As shown in FIGS. 2A and 2B, the controlling portion 2 includes a base 2c, a linkage assembly 2a disposed on the base 2c, and a shield 2b located in the middle of the base 2c covering a portion of the linkage assembly 2a.

As shown in FIGS. 3A and 3B, the linkage assembly 2a includes an actuating member 20 movably disposed on the base 2c, two driving members 21 disposed on the opposite sides of the actuating member 20 (as shown in FIGS. 2A and 2B) and driven by the actuating member 20, a sliding member 22 driven by the driving member 21 and movably disposed on the base 2c, a passive member 23 driven by the sliding member 22, a connecting member 24 connected to the passive member 23 and the connecting rod 9, and an adjusting member 25 used for adjusting the position of the sliding member 22.

It should be noted that since the configurations of the left and right sides (as indicated by arrow X) of the actuating member 20 are the same, FIGS. 3A and 3B only show the configuration of one side of the actuating member 20, and the configuration of the other side is omitted.

The actuating member 20 may move away from or close to the base 2c (e.g., moving in the direction of arrow Z, as indicated), may displace along a surface of the base 2c (moving on the plane formed by arrow X and arrow Y), and is covered by a shield 2b thereon.

In an embodiment, in the actuating member 20 a slice body 20a has a groove 201 (as shown in FIG. 3A), two side walls 20b, 20c extend from left and right sides (as indicated in the direction of arrow X) of the slice body 20a respectively, and two track 200 (elongated grooves extending upward and downward along the direction of the arrow Y) are disposed on the side walls 20b, 20c. A plurality of rode bodies 31, 32 cross the side walls 20b, 20c and pass through the tracks 200 (setting in the direction of arrow X as shown in FIG. 2B). An external force moves the rod bodies 31, 32 in the track 200, causing the actuating member 20 to move along the surface of the base 2c, i.e., moving upwards or downwards relative to the base 2c (moving in the direction of arrow Y).

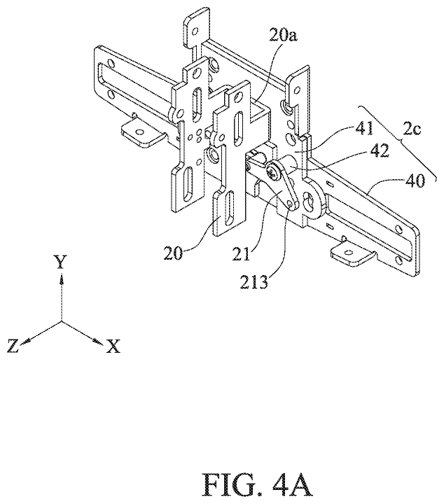

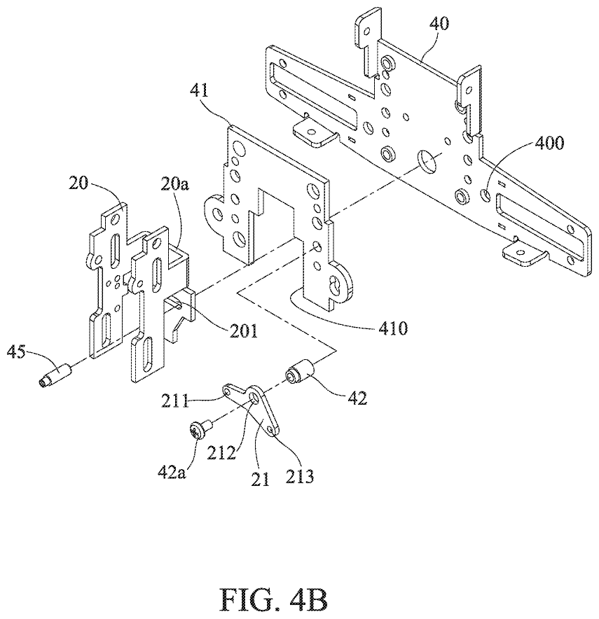

As shown in FIGS. 4A and 4B, the base 2c includes a baseboard 40 having a configuration hole 400 and an auxiliary board 41 screwed to the configuration hole 400. The auxiliary board 41 is concave and is disposed on the front side of the baseboard 40. The slice body 20a of the actuating member 20 can access the notch 410 of the auxiliary board 41 along the front and back directions (i.e., in the direction of arrow Z) by an external force to be away from or close to the base 2c.

The driving member 21 can be connected to the actuating member 20, such as a cam, which is pivotally connected with the base 2c such that one side of the driving member 21 is connected to the actuating member 20 and the other side thereof is connected to the sliding member 22.

In an embodiment, the driving member 21 is formed with a first hold 211, a second hole 212 and a third hole 213 from left to right, as shown in FIG. 4B, and a rod member 45 passes through the first hole 211 and the groove 201 of the slide body 20a of the actuating member 20, enabling the driving member 21 to move along with the actuating member 20 through the rod member 45. As shown in FIGS. 4A and 4B, the rod member 45 props against the baseboard 40 of the base 2c, and the actuating member 20 can access the notch 410 of the auxiliary board 41 along the front and back directions (along the direction the arrow Z) of the rod member 45, so as to be away from or close to the base 2c. Therefore, the rod member 45 enables the actuating member 20 to move away from or close to the base 2c, and enables the driving member 21 to move along with the actuating member 20. However, it should be understood that the manners in which the driving member 21 moves away from or close to the base 2c and the driving member 21 is connected to the actuating member 20 are not limited to the above.

As shown in FIGS. 4A and 4B, a rotating shaft 42 passes through the second hole 212 and has one end fixed to the auxiliary board 41 of the base 2c (not fixed on the baseboard 40) and the other end positioned on the driving member 21 with a nut 42a. The driving member 21 is pivotally connected with the base 2c, with the rotating shaft 42 in the second hole 212 as a rotating pivot. The left end and the right end of the driving member 21 move relative to each other, and the actuating member 20 can move relative to the sliding member 22.

In an embodiment, the driving member 21 passes through the third hold 213 by a rod member (not shown), and moves along with the sliding member 22. It should be understood that the linkage manner in which the driving member 21 and the sliding member 22 is not limited to the above.

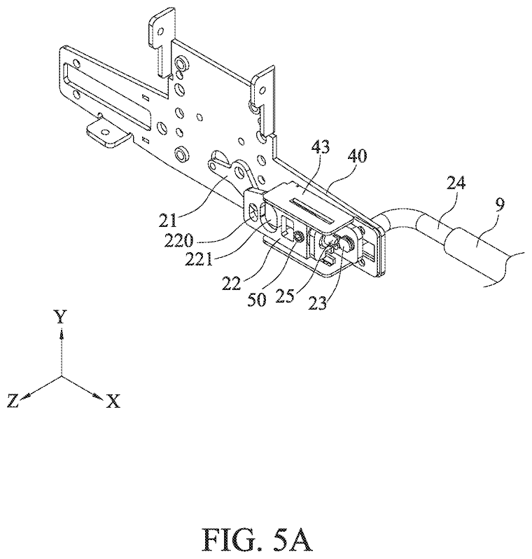

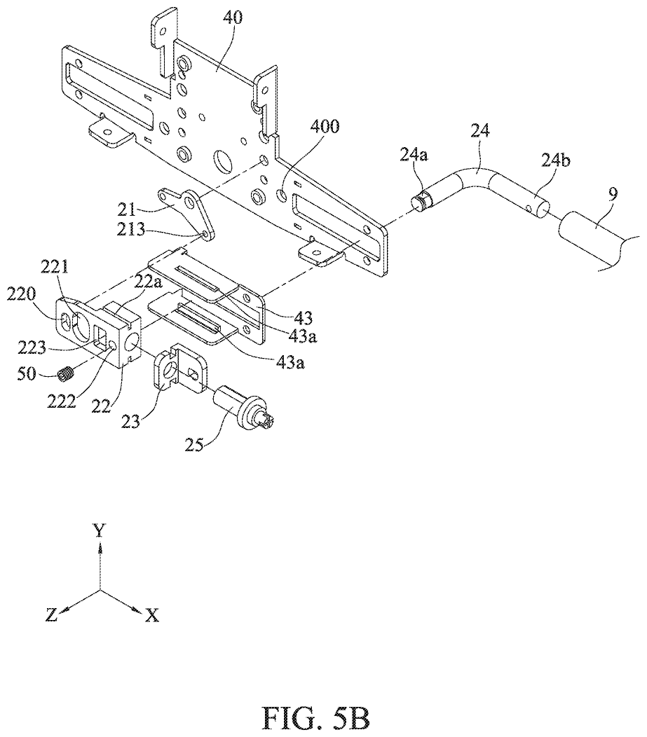

The sliding member 22 is connected to the driving member 21 and moves along the surface of the base 2c. The sliding member 22, such as a slider shown in FIGS. 5A and 5B, has at least one recess 220, allowing the rod member (not shown in the figure) passing through the third hole 213 to slide up and down (along the direction of arrow Y) in the recess 220. The sliding member 22 can move along with the driving member 21 through the track structure (i.e., the recess 220, the third hole 213 and the rod member).

In an embodiment, a limiting member 43 is disposed on the wings of the left and right sides of the baseboard 40, such as an open rectangular frame, which accommodates the sliding member 22 in a movable manner, for example, by means of the engagement of a rib 43a of the limiting member 43 with a channel 22a of the sliding member 22 to control the displacement direction (along a direction of arrow X) and the displacement distance of the sliding member 22. It should be understood that the manner in which the sliding member 22 moving relative to the base 2c is not limited to the above.

In an embodiment, the actuating member 20 (moving along the direction of arrow Y) and the sliding member 22 (moving along the direction of arrow X) move in different directions.

In an embodiment, the sliding member 22 further includes an opening 221, which is approximately elliptical and will reveal the configuration hole 400 of the baseboard 40 as the sliding member 22 arrives at the target position.

In an embodiment, the sliding member may include a via 222 for a set member 50 to be received therein, and a hollow portion 223 used for saving casing material.

The passive member 23 is an L-shaped block, as shown in FIGS. 5A and 5B, which is fixed to the sliding member 22 by the adjusting member 25.

In an embodiment, the adjusting member 25 includes a thread, such as a screw thread, which is bolt jointed with the passive member 23 and the sliding member 22, and tunes the distance between the passive member 23 and the sliding member 22. It should be understood that the configuration of the adjusting member 25 is not limited to the above.

Moreover, the set member 50 (such as a set screw thread) props against the adjusting member 25 to prevent the adjusting member 25 from loosening.

It should be understood that the passive member 23 may be adopted or omitted as required, or even be integrated with the sliding member 22, and the adjusting member 25 can also be adopted or omitted as required, and is not limited to the above.

The connecting member 24 is an L-shaped rod body, and has one end 24a passing through the baseboard 40 and fixed to the passive member 23 and the other end 24b fixed to the connecting rod 9. It should be understood that the configuration regarding the connecting member 24 is not limited to the above.

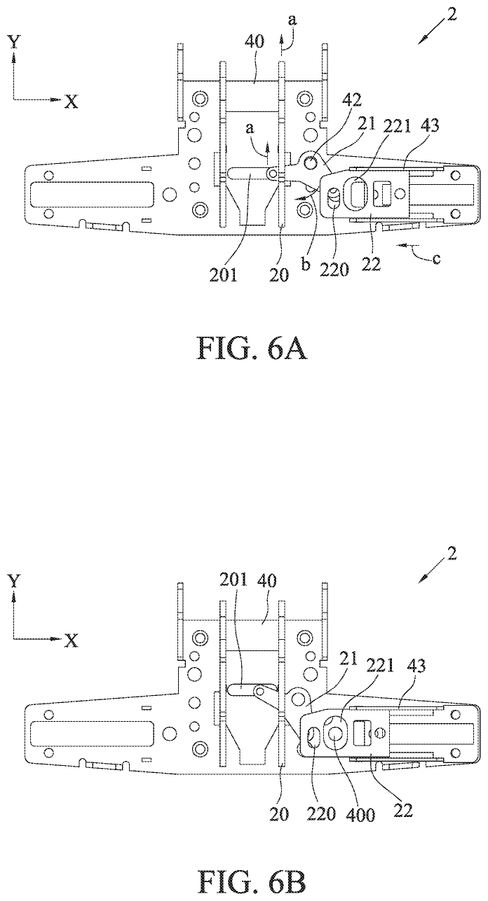

Therefore, when the linkage assembly 2a of the controlling portion 2 are actuated, an external force is provided to move the actuating member 20 along the rod member 45 away from the base 2c to an initial position (see the position outside the notch 410 of the auxiliary board 41 shown in FIG. 2B or FIG. 4A). Then, as shown in FIGS. 6A and 6B, the actuating member 20 moves upward and downward relative to the base 2c (or the baseboard 40) (along the displacement direction a of arrow Y), so as to drive the driving member 21 to rotate relative to the rotating shaft 42, so that the left end of the driving member 21 is displaced upward (along the displacement direction a), while the right end of the driving member 21 is deflected downward (along the displacement direction b) to drive the sliding member 22 to displace linearly (along the displacement direction c) along the limiting member 43 (referring to the direction of arrow X) and the passive member 23 to displace linearly and synchronously, and to make the connecting member 24 displace linearly (along the direction of arrow X) along with the passive member 23. Thus, driven by the connecting member 24, the connecting rod 9 will drive the driving mechanism 11 in a linear way (along the direction of arrow X), to cause the latch 10 to extend or retract.

It should be understood that if the actuating member 20 is located in the notch 410 of the auxiliary board 41, the actuating member 20 will abut against the auxiliary board 41 and cannot move upward and downward relative to the base 2c (or the baseboard 40).

In summary, the controlling portion 2 of the door lock 1 of the present disclosure is designed based on the opening 221 of the sliding member 22. When the sliding member 22 arrives at the target position, the configuration hole 400 of the baseboard 40 is exposed from the opening 221, as shown in FIG. 6B. Therefore, to assembly he door lock 1, there is no need to consider the configuration hole 400 of the base 2c to be equipped with the actuating member 20, the driving member 21, the sliding member 22, the passive member 23, the connecting member 24, the adjusting member 25 and other components, separately. Instead, the linkage assembly 2a can be assembled firstly, and then the linkage assembly 2a can be mounted on the base 2c. A user can thus penetrate a locking fastener (such as a screw thread) into the configuration hole 400 by exposing the configuration hole 400 of the baseboard 40 from the opening 221.

Moreover, since the configuration hole 400 of the baseboard 40 will be revealed by the opening 221, the screw thread can be set in the configuration hole 400 directly from the opening 221 without removing all the parts of the controlling portion 2 when the door lock 1 is repaired.

Further, since the controlling portion 2 appears to be the adjusting member 25, a user can twist the adjusting member 25 by means of an adjusting tool (such as a slotted screw driver or a cross screw driver) and finely tune the distance between the passive member 23 and the sliding member 22. Therefore, the position of the connecting member 24, the connecting rod 9, the driving mechanism 11 and other components can be finely tuned indirectly, so that the latch 10 can be presented in the best extended position or the best retractable position (located in the direction of arrow X).

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A door lock, comprising:
at least one latch portion; and
a controlling portion configured for actuating the latch portion, the controlling portion including a base having a configuration hole and a linkage assembly disposed on the base, wherein the linkage assembly comprises:
an actuating member movably disposed on the base;
a driving member connected to the actuating member;
a sliding member connected to the driving member and movably disposed on the base, wherein the sliding member has at least one opening; and
a connecting member connected to the sliding member and the latch portion and configured for enabling the sliding member to drive the connecting member to actuate the latch portion and exposing the configuration hole from the opening when the actuating member drives the driving member to actuate the sliding member.

2. The door lock of claim 1, wherein the actuating member is movable away from or close to the base.

3. The door lock of claim 1, wherein the actuating member moves along a surface of the base.

4. The door lock of claim 1, wherein the driving member is pivotally connected with the base, with one side of the driving member being connected to the actuating member and the other side of the driving member being connected to the sliding member.

5. The door lock of claim 1, wherein the sliding member is movable along a surface of the base.

6. The door lock of claim 1, further comprising an adjusting member configured for adjusting a position of the sliding member.

7. The door lock of claim 6, wherein the adjusting member has a screw thread for being engaged with the sliding member.

8. The door lock of claim 1, further comprising a passive member cooperating with the sliding member.

9. The door lock of claim 8, further comprising an adjusting member connected to the passive member and the sliding member for adjusting a distance between the passive member and the sliding member.

10. The door lock of claim 1, wherein the actuating member and the sliding member move in different directions.
